(19) United States
(12) Patent Application Publication
(10) Pub. No.: US 2019/0163973 A1
(43) Pub. Date: May 30, 2019

(54) DETERMINATION OF SMART DEVICE POSSESSION STATUS BY COGNITIVE CLASSIFIER PATTERN TRACKING USING MESH NETWORKS

(71) Applicant: International Business Machines Corporation, Armonk, NY (US)

(72) Inventors: Susann M. Keohane, Austin, TX (US); Jeb R. Linton, Manassas, VA (US); Dave K. Wright, Riverview, MI (US)

(21) Appl. No.: 15/825,661

(22) Filed: Nov. 29, 2017

(51) Int. Cl. G06K 9/00; H04W 8/00; H04L 29/08; G06N 3/08; G06N 3/04

(52) U.S. Cl. CPC G06K 9/00496; H04W 8/005; G06N 3/0454; G06N 3/084; H04L 67/1068

(57) ABSTRACT

Information is detected from additional devices within a detectable vicinity of a first smart device. The additional devices are identified by analyzing the information detected from the additional devices. Contextual information corresponding to the first smart device is accessed and expected patterns corresponding to the first smart device are learned, based on compiling combinations of detected additional devices in the vicinity of the first smart device and the contextual information corresponding to the detectable vicinity of the first smart device. Responsive to determining inconsistency between the expected patterns corresponding to the first smart device over time, and the information detected from the additional devices within a current detectable vicinity of the first smart device in combination with the current contextual information corresponding to the first smart device, a notification indicating an unexpected pattern of the first smart is generated.

### FIELD OF THE INVENTION

The present invention relates generally to the field of machine recognition of devices within an environment, and more particularly to automatic determination of lost or stolen status of a smart device.

### BACKGROUND OF THE INVENTION

Smart devices are increasingly relied upon by users for communication, information source, and as a source for variety of available tools. This is supported by observation of users keeping their smart device accessible, regardless of their activity, and using smart devices even in situations that are inconvenient or inappropriate.

Smart devices, such as smart phones, tablets, laptop computers, smart watches, and desktop computers, are commonly recognized. However, there are increasingly more devices that are able to interact with other devices wirelessly, such as, but not limited to, automobiles, appliances, security cameras, televisions, printers, sockets, and devices to control or monitor lighting, shades, temperature, and entry or exit. Smart devices share similar capabilities of receiving and transmitting information wirelessly, and in most cases, able to recognize and communicate with other devices, and operate interactively and autonomously.

Smart devices interconnect users at multiple levels, such as audio conversations, text messaging, social media post alerts, news alerts, and warnings, and facilitate control and monitoring of users and their environments. In some instances, smart devices offer personal services by operation of available applications (“apps”) selected and loaded on smart devices by users. As users develop a growing dependency on smart devices, the importance of access and protection of smart devices has also grown.

### SUMMARY

Embodiments of the present invention disclose a method, computer program product, and system for providing a notification of an unexpected pattern associated with a smart device. The method for provides for one or more processors to detect information from one or more additional devices within a detectable vicinity of a first smart device. One or more processors identify the one or more additional devices by analyzing the information detected from the one or more additional devices. One or more processors access contextual information corresponding to the first smart device. One or more processors determine expected patterns corresponding to the first smart device, based on compiling combinations of additional devices in the detectable vicinity of the first smart device and the contextual information corresponding to the detectable vicinity of the first smart device, over a predetermined timeframe, and responsive to determining inconsistency between the expected patterns corresponding to the first smart device over the predetermined timeframe, and the information detected from the one or more additional devices within a current detectable vicinity of the first smart device in combination with current contextual information corresponding to the current detectable vicinity of the first smart device, one or more processors generate a notification indicating an unexpected pattern of the first smart.

### BRIEF DESCRIPTION OF THE SEVERAL VIEWS OF THE DRAWINGS

FIG. 1 is a functional block diagram illustrating a distributed data processing environment, in accordance with an embodiment of the present invention.

FIG. 2 illustrates operational steps of a device training program, inserted on a server within the distributed data processing environment of FIG. 1, in accordance with an embodiment of the present invention.

FIG. 3 illustrates operational steps of a device context program, inserted on a smart device within the distributed data processing environment of FIG. 1, in accordance with an embodiment of the present invention.

FIG. 4 depicts a block diagram of components of a computing system, such as a server computer or smart device, capable of operationally performing the device training program, and the device context program, in accordance with an embodiment of the present invention.

### DETAILED DESCRIPTION

Embodiments of the present invention recognize that electronic devices enabled to receive and/or transmit information, interacting with other devices by use of wireless connectivity, are pervasive, and loss or misuse of such devices can be of significant concern to most users. Embodiments of the present invention provide a method, programmable product, and system for generation of a response action when a device, such as a smart device, is determined to be lost, stolen, or misused, based on contextual conditions, including a proximity of additional smart devices, environments, other contextual clues (RFID, Networks, light, sounds, etc.), and associated conditions and attributes. In some embodiments, lost, stolen, or misuse conditions of a smart device are determined based on machine learning of user patterns and behaviors associated with the smart device and detection of additional devices in proximity of the smart device in various environments defining the user's patterns and behavior. Some embodiments of the present invention identify whether a friend or family member with a smart device is within a vicinity of a trusted network of devices, providing an indication of safety or activity, while still providing a level of anonymity.

In response to determining unexpected detected devices or contextual conditions, deviating from learned patterns and behaviors of a user, some embodiments of the present invention generate a response action, such as a notification or alert, which is transmitted to one or more additional smart devices, in response to a first smart device deviating from expected patterns, such as failing to detect expected known devices at a particular set of location(s) and time conditions. The additional smart device(s) may be pre-determined to receive a notification alerting a user to the unexpected patterns found for the first smart device, for example, suggesting that the first device is lost or stolen. In some embodiments, responsive to determining unexpected patterns of the first smart device, such as determining unknown devices in the detectable vicinity of the first smart device, along with unexpected current contextual information (conditions) of the detectable vicinity of the first smart device, a locking condition may be initiated to disable functions of the first smart device. In yet other embodiments, some level of transmission (not limited to e-mail, text, phone call, or other electronic communication) may continue to be emitted by the first smart device, subsequent to disabling of functions, to assist in determining a location of a lost or stolen smart device.

In some embodiments of the present invention, multiple-input and multiple-output (MIMO) techniques are used to leverage a cooperative wireless mesh network to validate one or more devices within a vicinity of a particular smart device. A mesh network is a network topology in which each node relays data for the network. All mesh nodes cooperate in the distribution of data in the network. Wireless mesh networks can be considered a type of Wireless ad hoc network and may be recognized by identification of devices participating in the mesh network. In some embodiments of the present invention, multiple-input and multiple-output (MIMO) techniques are used to validate the proximity of a smart device to other devices in the vicinity of the smart device. Multiple-Input Multiple-Output (MIMO) is a wireless mesh technology that uses multiple transmitters and receivers to transfer more data at the same time.

In some embodiments, the cooperative mesh network will be used to detect when a particular smart device is in proximity of known devices, and determine whether the particular smart device is in an expected environment defined by contextual information, which includes, but is not limited to, expected conditions of location, date, time, elevation, and proximity of known devices. Other embodiments of the present invention determine a probability of whether the smart device is with its owner, or conversely, whether the smart device is lost or stolen. The probability is determined by analysis of current detected devices in the vicinity of the smart device and the current conditions (contextual information) associated with the smart device, as compared to expected device detection and conditions learned over time by training. In yet other embodiments, a smart device detection of unknown devices, absence of known devices, or abnormal use of the smart device, may not generate an alert or notification if checking scheduling activity functions, such as an electronic calendar entry or memo note, confirms the activity or location of the smart device as being expected. For example, if a first smart device is in an unusual combination of location, time, and proximity to known devices detectable via a wireless network, such as at a work location in the middle of the night for a normally scheduled day job, the first smart device may generate an alert or notification sent to a second smart device designated by the user. However, if the calendar or saved memo of the smart device indicated a schedule change, expecting to be at the work location at an unusual time, the smart device would not generate a notification or alert.

Conditions associated with the detection of devices in proximity to the smart device, also referred to within a detectable vicinity of the smart device, may include, but are not limited to, location, date, time, calendar, and memo entries. Location of the smart device may be determined by global positioning system (GPS) functionality, and date and time determination functions are readily available to, or accessible by, most smart devices. Scheduling activity functions, such as calendar and memo entries, may be available to smart devices by applications (apps) that may be included as default functions, or added by downloading free or purchased apps. Calendar and memo notes enable recording of planned activities, reminders, appointments, travel, or to-do lists, for example. In some embodiments of the present invention, smart devices send out probing signals, such as locating/identifying Wi-Fi networks, and cell phone transmission towers, and are enabled to identify devices by media access control (MAC) address. Sources of transmissions from devices identify and associate devices with particular environments in which the smart device may be located. For example, detectable device transmissions may include cell phones, GPS devices in your car, RFID, E-Z Passes, Wi-Fi systems, and wireless devices, such as printers, televisions, tablets, laptops, and cameras, among others.

In some embodiments of the present invention, a multilayer perceptron (MLP) is used to generate a machine learning model to determine the probability that the smart device is lost, stolen, or being misused. The determined probability reflects whether the smart device is in an expected, or unexpected environment, as is determined by the detection of devices in the proximity of the smart device, and the contextual information associated with the current position of the smart device, which includes location, time, date, and other attributes associated with the environment of the smart device. In other embodiments, a Long/Short Term Memory (LSTM) classifier may be used alone or in combination with a MLP to generate the machine learning model to determine the probability that the smart device is in an expected environment. The machine learning model is based on establishing a pattern of expected environments in which the smart device of the user is repetitively found. The patterns are learned based on the behavior of the user of the smart device with respect to detected devices and contextual information associated with the environments in which the smart device is found.

A multilayer perceptron (MLP) is a class of feedforward artificial neural networks that includes at least three layers of nodes. Each node of the MLP, other than the input nodes, behaves as neuron that uses a nonlinear activation function. MLP utilizes a supervised learning technique, called backpropagation, for training the neural network by providing expected outputs for a given set of inputs. Learning occurs in the perceptron by changing connection weights after each piece of data is processed, based on the amount of error in the output compared to the expected result. Long/Short Term Memory (LSTM) is a type of recurrent neural network that utilizes loops to allow information to persist, and enabling long-term dependencies. The loops can be thought of as multiple copies of the neural network, each passing previously obtained information (memory) to a successor. In some embodiments of the present invention, the input information is represented as vectors. An LSTM utilizes multiple layers in which the vectors of information are connected from outputs of one node to the inputs of others, and includes pointwise operations. A cell state propagates through the chain of layers and utilizes gates to add or remove information to the cell state comprised of a sigmoid neural net layer and pointwise multiplication operation. Performing operations on the old cell state determines a degree of update to new candidate values of the new cell state. Filters are applied to output determined parts of the new cell state.

Embodiments of the present invention refer to “known” devices as devices transmitting a detectable signal which may consistently identify the device. For example, every few minutes, a cellular phone connects to a cellular network to perform various tasks. The most important task is to inform the Home Location Register (HLR) where it is, or which Base Transceiver Station (BTS) it's currently connected to, determining the closest cellular tower from its current location. Each time the device checks in, it sends identification information to the network, such as phone number, serial number, and a few other pieces of data. The first request for a call to the cell phone goes to the home location register (HLR) so that the network knows where to find the target cell phone and contact it. Additionally, the information serves to insure the cell phone is connected to the most optimum base transceiver station (BTS), as determined by signal strength and BTS capacity.

A “known” device may be a component of a wireless network, or a device that utilizes a wireless network for communication or information access, or transmits a shorter range signal. Such devices are identifiable by a media access control (MAC) address, such as that of a router, digital modem, switch, bridge, gateways, wireless adapters, wireless access points (WAPs), and network interface cards (NICs) of laptop computers, tablets, smart phones, and smart watches. In some embodiments, a known device may be appliances, cameras, tagged items with radio frequency identification (RFID), ZigBee, Bluetooth, and Bluetooth Low Energy (BLE) transmitting devices, and Near Field Communications (NFC) devices, among others, (ZigBee is a registered logo and trademark of ZigBee Alliance, in the U.S. and other countries world-wide), (BLUETOOTH is a registered logo and trademark of Bluetooth SIG, Inc., in the U.S and other countries world-wide).

Some embodiments of the present invention consider locations in which a smart device resides for a particular time as an expected environment for the smart device. A set of devices detected by the smart device in the expected environment, along with information including the location, time of day, day-of-the-week, and other attributes associated with the expected environment, are used to identify the set of devices as known devices. For example, a user's smart phone detects the cell phones of co-workers, as well as a wireless router, the user's smartwatch, and the wireless adapters of laptop computers in the user's vicinity that are within a detectable proximity. The set of detected devices are typically found within a particular environment, within the vicinity of the smart phone, on particular days of the week and a particular time range of the day. The presence of certain devices (e.g., wireless router) may carry more weight in determining the probability of the user's smart device being in an expected environment (user's work environment), than the detection of a particular co-worker, who may travel to other locations often. Other expected environments of a user's smart device may include detected devices and contextual information corresponding to a home of the user, gyms, libraries, social gathering establishments, friends and neighbors homes, and frequently attended shops and stores, for example.

Embodiments of the present invention utilize detection of additional devices by a user's smart device, in combination with contextual clues, also referred to as contextual information, to determine the probability that the user's smart device is lost or stolen, and may generate an alert or notification, and may lock functions of the smart device until disabled by the user. Contextual information may include determination of the smart device location which, for example, may be determined by a GPS function of the smart device. Other contextual information may include the date, day of the week, and time of day, for example, detection of a device in the vicinity of the user's smart device on a Friday evening at the location of a frequented restaurant may produce a higher probability that the user's smart device is in an expected environment, whereas failure to detect known devices at a location of a frequented gym, on a weeknight after midnight, may generate a probability that the smart device has been left behind (lost).

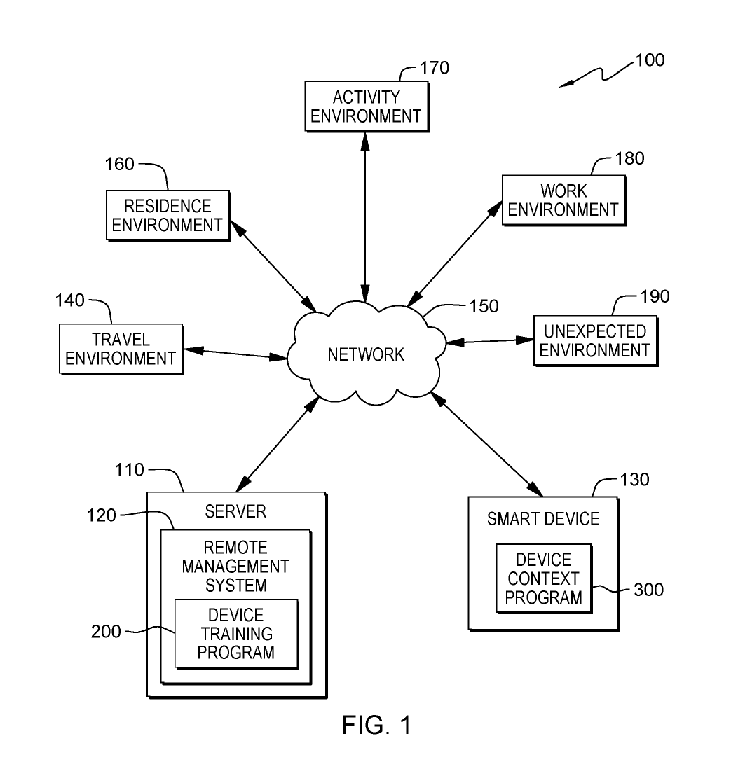

The present invention will now be described in detail with reference to the Figures. FIG. 1 is a functional block diagram illustrating a distributed data processing environment, generally designated 100, in accordance with an embodiment of the present invention. Distributed data processing environment 100 includes server 110, smart device 130, travel environment 140, residence environment 160, activity environment 170, work environment 180, and unexpected environment 190, all interconnected via network 150.

Network 150 can be, for example, a local area network (LAN), a telecommunications network, a wide area network (WAN), such as the Internet, a virtual local area network (VLAN), or any combination that can include wired, wireless, or optical connections. In general, network 150 can be any combination of connections and protocols that will support communications between server 110, smart device 130 (user's smart device), and travel environment 140, residence environment 160, activity environment 170, work environment 180, and unexpected environments 190, in accordance with embodiments of the present invention.

Travel environment 140 may indicate a persistent location change of smart device 130 as a function of time. Some embodiments of the present invention determine a context of persistent, or near-persistent change of location of smart device 130, and in some cases change in altitude, as indicating travel. Detection of “known devices” while traveling in combination with day and time information may indicate expected environments, such as use of public transportation daily to work. Expected travel may be determined by detection of user wearable devices, such as a smart watch, in proximity of smart device 130, while a persistent location change is detected. For example, a BLUETOOTH wireless audio transmitting device (e.g., MP3 player with wireless earphones) may be detected while the location of smart device 130 of the user is persistently or continually changing, such as when the user is walking, jogging, or cycling.

In the case of travel without the validation of detecting known devices and contextual clues, embodiments of the present invention may enlist accessible electronic calendar or memo entries to determine a probability of planned travel that may be outside of otherwise expected environments. If the change of location of smart device 130, which may typically indicate travel, is determined to be planned activity, as a result of verifying entries to electronic calendars or electronic memos, notifications regarding smart device 130 as being stolen or lost, are suppressed.

Residence environment 160 includes a location space in which the user of smart device 130 resides and may refer to as home, or where the user lives. Residence environment 160 may be, for example, a house, an apartment, a condominium, a hotel, a moored boat, or an enclosed space in which the user resides, retains possessions, and typically sleeps. Residence environment 160 includes additional devices, which are detectable by smart device 130, and the repetitive detection of the additional devices included in residence environment 160, by smart device 130, results in the additional devices being considered “known devices” associated with residence environment 160. In some embodiments of the present invention, the known devices associated with residence environment 160 include tablets, wireless cards and adapters of computers, wireless routers, smart televisions and smart appliances, which can transmit and receive data through a Wi-Fi connection, RFID devices, NFC devices, and BLUETOOTH devices, among others. In some embodiments of the present invention, MIMO detected from the devices of residence environment 160 form a cooperative wireless network and validate known devices in proximity of smart device 130. Detection of one or a combination of the known devices associated with residence environment 160, and determination of a location of smart device 130 that is consistent with residence environment 160, results in a probability that smart device 130 is in an expected environment, and the user of smart device 130 is in possession of smart device 130. Conversely, detection of one or a combination of the known devices associated with residence environment 160 in combination with a different location than that of residence environment 160 may indicate smart device 130 (and possibly other devices of residence environment 160) have been stolen or lost.

Activity environment 170 includes a set of locations at which the user of smart device 130 performs or partakes in certain respective activities, exclusive of the locations corresponding to residence environment 160, and work environment 180. Activity environment 170 includes, for example, frequently eating a meal at a restaurant, diner, café, or other eating establishment; exercising at a gym; meeting friends socially at a night club or tavern; attending a movie or concert; and walking, jogging, cycling, or other frequent outdoor activity. Activity environment 170 also includes contextual clues associated with each location of the set of locations, which contribute to identifying the activity and the presence of smart device 130 as expected. The contextual clues may include, but are not limited to: detection of other devices previously (and typically, repetitively) associated with a particular location, a date or day of the week associated with the particular location, a time of day associated with the particular location, and content of electronic calendar or memo entries.

For example, detecting a particular set of other devices, such as multiple smart phones, mesh networks, and a wireless router, at a location consistent with a workout gym frequented by the user of smart device 130, at 5:25 p.m. on a Wednesday, may indicate that the user of smart device 130 is attending a workout session as a member of a gym. The expected activity is confirmed by detection of previously, repetitive detection of a known wireless router and detection of smart phones of other members previously detected and attending the gym at the same time. Alternatively, determining the location of smart device 130 at the gym of which the user of smart device 130 is a member, and the wireless router device known as associated with the particular gym, but failing to detect any additional devices, such as smart phones of other members, or determining the time of day to be 2:00 a.m., would result in a probability that smart phone 130 is lost, and probably left at the gym frequented by the user of smart device 130. Smart device 130, operating device context program 300 (discussed in detail below), generates a response activity, such as an alert or notification, for example, upon determining a triggering probability level that smart device 130 is lost, stolen, or misused.

In some embodiments of the present invention, the user of smart device 130 includes a wearable device, separate from smart device 130, which is detected as a known device in the near vicinity of smart device 130. The wearable device, worn by the user of smart device 130, may serve to indicate a physical proximity or separation of smart device 130 from the user and may be included as a contextual clue in generation of a probability that the user's smart device is lost or stolen. Wearable devices that are detectable by smart device 130 may include, but are not limited to: a smart watch, an mp3 device attached to a user, a fitness bracelet, articles of clothing, footwear, and jewelry that transmits detectable signals.

Work environment 180 includes a set of locations at which the user of smart device 130 performs or partakes in certain work-related activities. The set of locations for work environment 180 may include a limited location area, such as an area surrounding an office in a building, or may include multiple locations within a building, multiple buildings, or involve travel in a vehicle to various locations. In some embodiments of the present invention, work environment 180 is determined as an expected environment of smart device 130 by association with contextual clues that may include detection of other known devices in proximity of smart device 130, and particular associations of location, day of the week, and time. For example, smart device 130 may detect the smart devices of other co-workers in the vicinity of smart device 130 on a day of the week and a range of time-of-day that would correspond to a work day. In addition, smart device 130 may detect a wireless network and office devices, such as wireless printers, that are recognized as expected in work environment 180.

In other examples, the user of smart device 130 may perform work by traveling different routes, making deliveries or repairs, or providing transportation. Smart device 130 may detect an initial location recognized as a starting and ending location of a work day, and detect devices associated with a transportation vehicle, and Wi-Fi networks within location areas frequented during travel. Significant deviations from expected location or detection of other devices may be confirmed as expected by referring to information entries made to calendar or memo notes accessible to device context program 300, which is discussed in detail below.

Unexpected environment 190 includes combinations of contextual clues that are not determined to be routine but are confirmed by other information sources available to device context program 300 operating on smart device 130. For example, information entries made to a calendar function or application of smart device 130 may indicate a day of vacation and travel to a named location. The location and detection of known devices may be unexpected for a particular day-of-the-week typically known as a work day; however, the calendar entry may confirm travel to the named location at the date and timeframe indicated by the entry, confirming the contextual clues as expected. In embodiments of such cases, notification or alert of the smart device being lost or stolen (or misused) is suppressed. In other embodiments, the absence of calendar or memo entries confirming unexpected travel, unexpected locations, and a lack of known devices, the smart device in the context of the day-of-the-week, and time of day, a probability of smart device 130 being lost or stolen (or misuse) is determined and notification or alert is generated if the probability exceeds a predetermined threshold.

Server 110 provides computing and operational support of remote management system 120, which is depicted as including device training program 200. In some embodiments of the present invention, server 110 is a host for remote management system 120 and device training program 200, as depicted in FIG. 1. In other embodiments, server 110 is remotely connected to remote management system 120 and device training program 200 (not shown as remote connection), which may be hosted on other devices, but are connected via network 150.

In some embodiments of the present invention, server 110 can be a management server, a web server, a mobile computing device, or any other electronic device or computing system capable of receiving, sending, and processing data, and supporting the operational functions of remote management system 120 and device training program 200. In other embodiments, server 110 can represent a server computing system utilizing multiple computers as a server system, such as in a cloud computing environment. In still other embodiments, server 110 can be a laptop computer, a tablet computer, a netbook computer, a personal computer (PC), a desktop computer, a personal digital assistant (PDA), a smart phone, or any programmable electronic device capable of performing programmable instructions supporting remote management system 120 and operation of device training program 200, within distributed data processing environment 100 via network 150. In another embodiment, server 110 represents a computing system utilizing clustered computers and components (e.g., database server computers, application server computers, etc.) that act as a single pool of seamless resources when accessed within distributed data processing environment 100. Server 110 may include internal and external hardware components, as depicted and described in further detail with respect to FIG. 5.

Remote management system 120 provides operational support and interfaces to device training program 200 enabling supervised learning techniques to be employed in MLP and LSTM model building and training. In some embodiments of the present invention, information is provided through interfaces to remote management system 120 generating MLP and LSTM input vectors. Additionally, expected outputs are provided through remote management system 120 to enable supervised learning for device training program 200. In some embodiments of the present invention, remote management system 120 includes functionality to disable smart device 130 in response to a probability of smart device 130 being lost, stolen, or misused, exceeding a predetermined threshold. In other embodiments, in response to determining that smart device 130 has been lost, stolen, or misused, remote management system 120 enables transmission from smart device 130 to facilitate location of the device.

Device training program 200 is a machine learning application that generates a model of expected combinations of detected devices in proximity of smart device 130, in combination with additional contextual clues, such as, but not limited to: location, rate of change of location, date, day-of-the-week, altitude, and electronic calendar or memo entries. In some embodiments of the present invention, device training program 200 utilizes MLP artificial neural networks receiving information as input vectors and utilizes a supervised learning technique called backpropagation for training the neural network by providing expected outputs for a given set of inputs. In other embodiments, a Long/Short Term Memory (LSTM) classifier may be used alone or in combination with a MLP to generate the machine learning model to determine the probability that smart device 130 is in an expected environment, and the user of smart device 130 is in possession of smart device 130. The LSTM classifier utilizes loops to allow information to persist. The machine learning model is based on a learned behavior of the user of smart device 130 with respect to environments in which the user is found, and the detected known devices and conditions associated with the environments.

MLP embodiments account for time-in-location of smart device 130 as an independent feature for the LSTM classifier. The LSTM recurrent neural network classifier learns dynamically through time as a dependent feature as time-variant output is factored in with variant time/location and other contextual feature data. Learning occurs by changing connection weights after each piece of data is processed, based on the amount of error in the output compared to the expected result. The multiple layers and non-linear activation enable distinguishing data that is not linearly separable. The resulting model of device training program 200 is applied to smart device 130 and operates as device context program 300. In some embodiments of the present invention, smart device 130 provides device training program 200, via interfaces associated with remote management system 120, with information regarding the location, detected devices, and contextual clues corresponding to the environment of smart device 130. Device training program 200 continually updates and refines the machine learning model and provides update capability to device context program 300.

In some embodiments of the present invention, a multilayer perceptron (MLP) is used to generate a machine learning model to determine the probability that the smart device is lost, stolen, or being misused. The determined probability reflects whether the smart device is in an expected, or unexpected environment, as is as determined by the detection of devices in the proximity of the smart device, the location, time, date, and other attributes associated with the environment of the smart device. In other embodiments, a Long/Short Term Memory (LSTM) classifier may be used alone or in combination with a MLP to generate the machine learning model to determine the probability that the smart device is in an expected environment. The machine learning model is based on a learned behavior of the user of the smart device with respect to environments in which the user is found, and detected devices and conditions associated with the environments.

A multilayer perceptron (MLP) is a class of feedforward artificial neural networks that includes at least three layers of nodes. Each node of the MLP, other than the input nodes, behaves as a neuron that uses a nonlinear activation function. MLP utilizes a supervised learning technique, called backpropagation, for training the neural network by providing expected outputs for a given set of inputs. Learning occurs in the perceptron by changing connection weights after each piece of data is processed, based on the amount of error in the output compared to the expected result. The multiple layers and non-linear activation distinguish MLP from a linear perceptron, enabling an MLP to distinguish data that is not linearly separable.

Long/Short Term Memory (LSTM) is a type of recurrent neural network that utilizes loops to allow information to persist, and enabling long-term dependencies. The loops can be thought of as multiple copies of the neural network, each passing previously obtained information (memory) to a successor. In some embodiments of the present invention, the input information is represented as vectors. An LSTM utilizes four layers in which the vectors of information are connected from outputs of one node to the inputs of others, and includes pointwise operations. A cell state propagates through the chain of layers and utilizes gates to add or remove information to the cell state comprised of a sigmoid neural net layer and pointwise multiplication operation. Performing operations on the old cell state determines a degree of update to new candidate values of the new cell state. Filters are applied to output determined parts of the new cell state.

Smart device 130 is a programmable electronic device capable of receiving and transmitting wireless communications. In embodiments of the present invention, smart device 130 is configured to operate device context program 300, detect other devices in the vicinity of smart device 130, and determine an identity of detected devices; distinguishing one detected device from another detected device. For example, smart device 130 detects transmitted signals of devices in the vicinity of smart device 130, uniquely identifies the detected devices, and associates the detected devices with contextual clues, which include, but are not limited to: location, rate of change of location, date, day-of-the-week, time of day, duration at a location, altitude and change of altitude, and information entered in an electronic calendar (or memo note) function, or application accessible to smart device 130. In some embodiments of the present invention, smart device 130 may be a smart phone, a tablet, a smart watch, a laptop computer, a smart TV, or other electronic device capable of operating device context program 300, determining contextual clues associated with time and location, and detecting and identifying other devices within a detectable proximity. Smart device 130 may include internal and external hardware components, as depicted and described in FIG. 5.

Device context program 300 is the operational application of the machine learning model generated and trained by device training program 200. Device context program 300 operates from smart device 130 and determines whether combinations of detected devices in the vicinity of smart device 130 and contextual conditions corresponding to smart device 130 suggests a high probability that smart device 130 is lost, stolen, or is being misused. Device context program 300, once trained by device training program 200, determines expected patterns of location, time, and detected devices in the vicinity of smart device 130. The expected patterns result from the routines and behaviors of the user of smart device 130, which are initially input as supervised learning of device training program 200, and subsequently refined by additional input and feedback through time. In some embodiments of the present invention, device context program 300 determines a probability that smart device 130 is lost or has been stolen or misused. Device context program 300 determines the probability based on the detected devices in the vicinity of smart device 130, and the contextual information of location, date, day-of-the-week, time of day, altitude, rate of change of location, as well as other conditions associated with smart device 130. Device context program 300 determines whether the lost, stolen, or misused probability exceeds a predetermined threshold, and confirming the threshold is exceeded, device context program 300 generates an alert or notification that is transmitted to one or more devices capable of receiving communication, such as SMS messaging, email, or audio messages.

In some embodiments of the present invention, an alert indicating smart device 130 is lost, stolen, or misused is received by remote management system 120, which initiates protective measures that may include disabling smart device 130, limiting functionality, based on the probability level, and generating a signal to facilitate location of smart device 130. In other embodiments, a notification sent as an email may include one or more functions that when activated may disable the device, limit functionality of the device, sound an audible alert, disable further notification and alerts, generate a transmission to facilitate location, or provide information of devices in the proximity of the lost or stolen smart device.

In some embodiments of the present invention, the probability of smart device 130 being lost, stolen, or misused is determined based on consideration of the cumulative detected conditions and devices in the vicinity of smart device 130, as compared to the weighted conditions associated with expected environments. For example, smart device 130 conditions may indicate a location consistent with a work environment, and detection of a Wi-Fi network consistent with the work environment, however, detection of other devices (associated with co-workers) are absent, and the day-of-the-week and time of day indicate a non-work schedule. Additionally, device context program 300 does not detect a wearable device typically worn by the user of smart device 130. The cumulative detected conditions, with heavier weights on worn devices and day-of-the-week schedule, generate a high probability that smart device 130 is lost; left at the user's work environment.

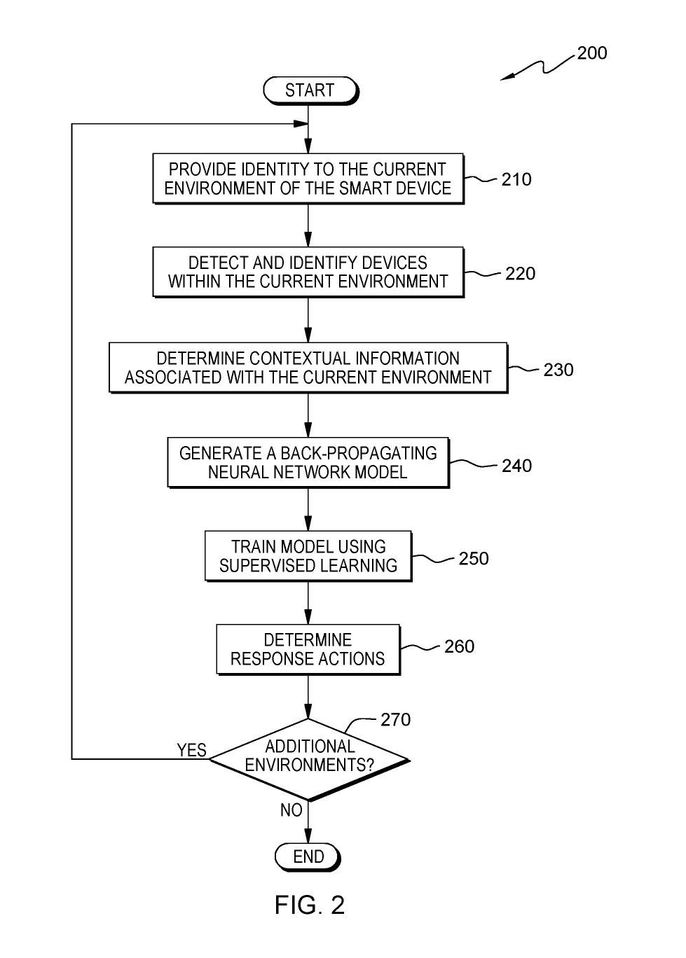

FIG. 2 illustrates operational steps of device training program 200, inserted on a server within the distributed data processing environment of FIG. 1, in accordance with an embodiment of the present invention. In some embodiments of the present invention, device training program 200 receives input and corresponding known output as part of supervised learning techniques to train the machine learning model for recognizing when smart device 130 is in an expected environment, or unexpected environment, and determining a probability that smart device 130 is lost, stolen, or misused.

Device training program 200 provides an identity to the current environment of the smart device (step 210). In some embodiments of the present invention, device training program 200 receives input indicating a current environment associated with smart device 130. In some embodiments, device training program 200 provides an identifying label to the current environment, distinguishing the environment from other environments of smart device 130. For example, device training program 200 may receive input indicating a current environment associated with a work location of the user of smart device 130. Device training program 200 identifies the current environment with a label, such as “main work location”, which may distinguish from other occasional work locations for the user of smart device 130. In some embodiments, device training program 200 may receive user input of a label for the current environment, and in other embodiments, device training program 200 may generate a label for the current environment.

Having provided an identity to the current environment, device training program 200 detects and identifies devices within the current environment (step 220). In some embodiments of the present invention, device training program 200 receives transmissions from devices in the vicinity of smart device 130 and identifies each detected device, distinguishing each from the other. In other embodiments, device training program 200 may probe for devices detectable within a proximity of smart device 130, and in response to detecting a reply transmission, device training program 200 identifies the detected devices and associates the devices with the current environment.

For example, device training program 200 receives input of transmissions from devices within the vicinity of smart device 130, which may include detection of a Wi-Fi network, a wireless printer, a laptop wireless network interface card of the user and of four other laptops used by co-workers of the user of smart device 130. Device training program 200 may also detect smart phones of co-workers, and a smart watch worn by the user of smart device 130. All detected devices are associated with the current environment. In some embodiments, the transmissions and identifications of devices associated with the current environment are manually input to device training program 200, whereas in other embodiments, device training program 200 receives detection of devices from smart device 130, provides identities to the detected devices, and associates the devices with the current environment.

Device training program 200 determines contextual information corresponding to the current environment (step 230). In some embodiments of the present invention, some or all of the contextual information is received by device training program 200 from user input. In other embodiments, some or all of the contextual information is obtained from smart device 130 directly, or other applications, functions, or on-line sources accessible to device training program 200. Contextual information is received by device training program 200 and may include, but is not limited to: location, rate of change of location, date, day-of-the-week, time of day, altitude, and electronic calendar entries and/or memo notes. The contextual information is associated with the detected devices and the current environment.

For example, contextual information received includes a global positioning system (GPS) location indicating that smart device 130 expected to be present in the current environment, generally from 8:00 a.m. to 5:00 p.m., with potential absence from noon to 1:00 p.m., each weekday. The contextual information indicates that smart device 130 varies only 25 feet in altitude (2^{nd} floor), and a horizontal range of less than 150 feet. Additionally, a wireless router providing a Wi-Fi network is detected at that location, along with a wireless printer, six laptops, and six smart phones, presumably belonging to co-workers of the user of smart device 130.

Device training program 200 generates a feedforward neural network model utilizing back-propagation training techniques (step 240). In some embodiments of the present invention, device training program 200 receives detected and identified devices, and the contextual information associated with the current environment as input to generate a neural network model. In some embodiments, an MLP is used to generate the model, whereas in other embodiments, a combination of an MLP and an LSTM are used to generate the model. The LSTM networks are a special type of recurrent neural network, capable of learning long-term dependencies. Propagation of information input in building the model includes determining information to retain and information to omit. A structure of a neural network model includes input nodes, or cells, that receive different types of input information, and connections to each hidden memory cells from each input node.

MLPs may include a single hidden cell layer, whereas LSTM networks may include multiple cell layers, and the cells may include gates to determine information to retain or omit during forward and backward propagation of the model. MLPs and LSTM based models include output cells, and the model structure connects the output vectors of one layer as the input of the subsequent layer in a given direction. For example, information received by each input cell as a vector quantity, is modified by pointwise operations (and applied and adjusted weights during supervised training), and output to each cell of the next (hidden/memory) layer to be received as input. Processing of information progresses from input cells to each of a first layer of memory cells, and from each first layer of memory cells information vectors modified by the first layer of cells are output, and received as input to each of second layer memory cells, and so on. Each cell of the last memory layer forwards modified information to each output cell. The information flows both forward and backward during training of the model.

Having generated a back-propagating neural network model, device training program 200 trains the model using supervised learning (step 250). Device training program 200 receives input information paired with known outcomes and processes the input through the machine learning model reaching an outcome, and then applying adjustments to weights associated with the layers of the model, based on the amount of error of the model result to the known outcome. The input information is repetitively processed forward and backward through the model, adjusting cell weights to attain the known outcome, and processing backwards, result in the applied input information. For example, known input information may include location, date/time, day-of-the-week, and a plurality of detected devices for a particular environment of smart device 130. The input information is transformed into vector values and received by the input cells. The input cells perform pointwise operations and may apply a weighted value, and sends the resulting value to each of the next layer of cells (hidden/memory cells). Processing continues through cell layers, resulting in an output, which is compared to a known or expected output. Adjustments to weights are made to minimize error between the actual output and the expected output. The process proceeds backwards from the output cells through the memory cells to the input cells, and again adjustments to weights are made. Processing iterates until the error is minimized, and the model then repeats processing for a different set of input and known output information.

Having trained the model for given known input and output information, device training program 200 determines response actions (step 260). Training of the model may include various factors in considering whether smart device 130 is lost, stolen, or misused. Device training program 200 includes weighted values in determining the probability of the status of smart device 130. Some input factors may carry more weight than others lost or stolen determinations, taking into account variations of an environment in which smart device 130 is located. For example, the absence detecting devices of several co-workers from a known work location on a Friday in July may carry less weight in determining a probability that smart device 130 is lost, due to vacations. In the same circumstances, the location, time of day, and the detection of a known work wireless network may carry much greater weight in determination of a probability that smart device 130 is lost.

In another example, detecting the absence of a wearable device, by the user of smart device 130, may carry a weight significant enough to generate a probability that smart device is lost that exceeds a pre-defined threshold, even though other contextual information and detected devices may indicate smart device 130 is in an expected environment.

Having completed supervised training of the neural network model, for a current environment, device training program 200 checks if there are additional environments to consider for training (decision step 270). Device training program 200 receives input as to whether additional environments for smart device 130 are to be included in the neural network model. For the case in which no additional environments are to be considered, device training program 200 ends (decision step 270, “NO” branch). For the case in which input is received indicating additional environments are to be included in the neural network model (decision step 270, “YES” branch), device training program 200 loops to step 210, and proceeds as described above. In some embodiments of the present invention, the back-propagating neural network generated in step 240 may require additional input cells or and additional layer of memory (hidden) cells, based on the type of input received. For example, for the case in which the detected devices and contextual information fail to match an expected environment under expected conditions, device training program 200 may require input from an electronic calendar file or application, or notes from an electronic memo function or application, which may confirm planned travel or planned alternate activity. Including the extra input sources may prevent false notifications and alerts, when infrequent changes to expected behavior associated with smart device 130 occurs.

The information input is received as a vector at each cell, modified by pointwise operations, and weights applied and modified during supervised learning. The resulting outputs are received as inputs to the subsequent layer of cells. Learning occurs in the perceptron by changing connection weights after each piece of data is processed, based on the amount of error in the output compared to the expected result. This is an example of supervised learning, and is carried out through backpropagation.

Having trained the neural network model for the current environment and contextual information (clues), device training program determines whether there are additional environments, (decision step 270), and having determined that there are no additional environments to which device training program 200 is to be trained (decision step 270, “NO” branch), device training program 200 ends.

For the case in which device training program 200 determines additional environment to which program 200 is to be trained, device training program 200 loops to step 210 and continues as described above (decision step 270, “YES” branch).

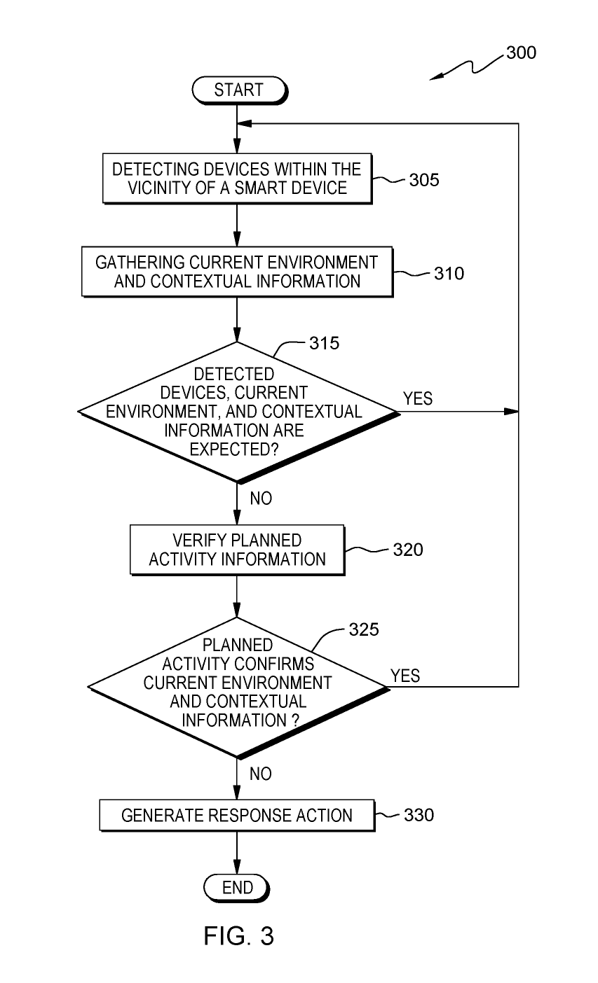

FIG. 3 illustrates operational steps of device context program 300, inserted on smart device 130 within the distributed data processing environment of FIG. 1, in accordance with an embodiment of the present invention. Device context program 300 results from supervised learning applied to a neural network model by device training program 200. Device context program 300 detects and determines devices in the vicinity of smart device 130, and the contextual information associated with the vicinity of smart device 130. The combination of currently detected devices in the vicinity of smart device 130 and the current contextual information associated with smart device 130 defines a current environment of smart device 130. The patterns of detected devices in the vicinity of smart device 130 in combination with the corresponding contextual information, iterated over time, form expected environments of smart device 130.

Device context program 300 calculates a probability that smart device 130 is lost, stolen, or misused, and generates a notification or alert, sent to pre-determined devices, if the probability exceeds a pre-determined threshold. In some embodiments of the present invention, device context program 300 operates in a continual loop at a pre-determined frequency. In some embodiments the pre-determined frequency is set as a default, in other embodiments the frequency is a user-selected feature.

Device context program 300 detects devices within the vicinity of the smart device (step 305). Device context program 300, operating on smart device 130, probes for, and detects devices within a detectable vicinity of smart device 130, at a pre-determined frequency. In some embodiments of the present invention, device context program 300 detects communication signals from devices in the vicinity of smart device 130 and identifies the devices based on identification information within the detected communication signals. For example, device context program 300 determines a wireless router as a source of a Wi-Fi network, by the MAC signature of the communication signals, and cell phones by their identification as they intermittently connect to cell towers. In some embodiments, device context program 300 detects other wireless signals, such as BLUETOOTH connections from near devices, near field communications (NFC) from devices in close proximity, or radio frequency identification (RFID) signals as they are energized by readers.

Device context program 300 gathers current environment information and contextual information of the area in the vicinity of smart device 130 (step 310). Device context program 300 receives location information of smart device 130, and time related information, such as the date, time of day, and day-of-the-week, and information regarding the rate of change of the location of smart device 130. In some embodiments of the present invention, device context program 300 accesses location and rate of change of location information from GPS functions within smart device 130, and accesses time related information from functions within smart device 130 or otherwise accessible to smart device 130. Device context program 300 compares the gathered location information to location information included in the training of the neural network model determine and identify the current environment of smart device 130.

For example, device context program 300 accesses the GPS information of smart device 130 and determines that the rate of change of location is minor; suggesting movement of smart device 130 is contained within a small area. Device context program 300 accesses a time application on smart device 130 and determines that it is 9:05 a.m. on a Tuesday. Device context program 300 compares the GPS location information of smart device 130 to contextual information applied during training of the neural network model that serves as the basis of device context program 300 and concludes that the location of smart device 130 is consistent with a place of work associated with the user of smart device 130.

Having detected devices in the vicinity of the smart device, and gathered current environment and contextual information, device context program 300 determines whether the detected devices, current environment, and contextual information are expected (decision step 315). Device context program 300, based on the trained neural network model, determines whether the detected devices and contextual information of the current environment are consistent with an expected set of devices and conditions in the vicinity of smart device. For the case in which device context program 300 determines that smart device 130 is in the vicinity of an expected set devices in an expected current environment, under expected conditions (decision step 315, “YES” branch), device context program 300 loops to step 305 and proceeds as described above, at a pre-defined frequency. For the case in which device context program 300 determines that smart device 130 is not in the vicinity of expected devices, or at an expected location for the gathered set of contextual information (decision step 315, “NO” branch), device context program 300 verifies planned activity information (step 320).

Planned activity information includes information recorded in calendar applications or functions, for example, and may also include content added in memo, note taking, or other applications that may be included on, or accessible to smart device 130. In some embodiments of the present invention, the user of smart device 130 may enter information regarding travel, appointments, vacation, or other activity that may result in smart device 130 residing in an unexpected current environment for a given set of detected devices and contextual information. Verifying sources that may include planned activity information in circumstances in which device context program 300 determines smart device 130 is not in expected environments and not in the vicinity of expected devices may alter calculation of probability that smart device 130 is lost, stolen, or misused, and may otherwise suppress an alert or notification.

For example, device context program 300 determines that smart device 130 is not in a work environment at 10:00 a.m. on a week day, and detected devices in the vicinity of smart device 130 are unknown. The location of smart device 130 is consistent with a building a few miles from the known work place of the user of smart device 130. Device context program 300 accesses the calendar application included on smart device 130 to verify if there is an entry of planned activity information, and determines an appointment scheduled the same day at 10:15 a.m., at an address consistent with the GPS location of smart device 130.

Having verified planned activity information, device context program 300 determines whether planned activity information confirms a current environment and contextual information associated with smart device 130 (decision step 325). For the case in which device context program 300 verifies a planned activity is entered and includes information that is consistent with the detected devices and contextual information currently associated with smart device 130 (decision step 325, “YES” branch), device context program 300 loops to step 305 and continues to detect devices in the vicinity of smart device 130, and gather contextual information currently associated with smart device 130, and proceeds as described above, at a pre-defined frequency of detection and information gathering.

For the case in which device context program 300 determines that planned activity sources fail to confirm smart device 130 is in an expected current environment, having recognized detected devices and contextual information (decision step 325, “NO” branch), device context program 300 proceeds to generate a response action (step 330). Device context program 300 assesses the detected devices, the contextual information, and the planned activity information, and generates a probability that smart device 130 is lost, stolen, or misused. In some embodiments of the present invention, device context program 300 may consider the location to be an expected environment but considers the current contextual information to be inconsistent with expected contextual information, such as smart device 130 being located at a work environment of a Friday night at 2:00 a.m., without detection of wearable devices of the user of smart device 130. In such a combination of information, device context program 300 generates a probability of smart device 130 being lost that exceeds a pre-determined threshold. The probability is influenced by higher weights given to the day-of-the-week and the time of day, as well as the absence of detected wearable devices, even though the work environment is familiar.

Determining a probability of smart device 130 not being in the possession of the user of smart device 130 (device is lost or stolen), device context program 300 generates a response action by sending a notification or alert to one or more other devices that have been pre-determined. The notification or alert may be one or a combination of text content, audio signal, light and/or color variations (e.g., flashing red), SMS message, email message, or phone call message. For example, device context program 300 may generate an email that the user of smart device 130 accesses on a laptop computer. Alternatively, device context program 300 may send an SMS message (alone or in addition to the email message) to another smart device used by a spouse, family member, co-worker, or friend of the user of smart device 130. In some embodiments of the present invention, device context program 300 may disable functions of smart device 300, subsequent to generating an alert or notification of the device being lost or stolen. In some embodiments, smart device 130 transmits a signal to facilitate the location of the lost or stolen smart device. In some embodiments, device context program 300 intermittently sends alerts or notifications until smart device 130 has been retrieved, which in one embodiment, may be indicated by entry of a retrieval code by the user of smart device 130. In another embodiment, the retrieval of a lost or stolen smart device 130 may be indicated by detection of a particular combination of detected devices and contextual information.

In some embodiments of the present invention, device context program 300 determines that smart device 130 is misused when functions of smart device 130 are operated under conditions in which the probability of smart device 130 being lost or stolen exceeds a pre-defined threshold. In addition to generating notifications and/or alerts, device context program 300, determining smart device 130 being lost or stolen and functions of smart device 130 being operated, disables the functions of smart device 130.

Having generated response actions, device context program 300 ends.

In some embodiments of the present invention, device context program 300 is trained to generate notifications indicating smart device 130 is in an expected current environment by the detection of known devices in combination with smart device 130 being in a known location, at a particular date and time (contextual information). Notifications sent to a parent's device, from smart device 130 may confirm that the parent's child is meeting with known users of other devices at a known location and time, offering a level of protection and awareness.

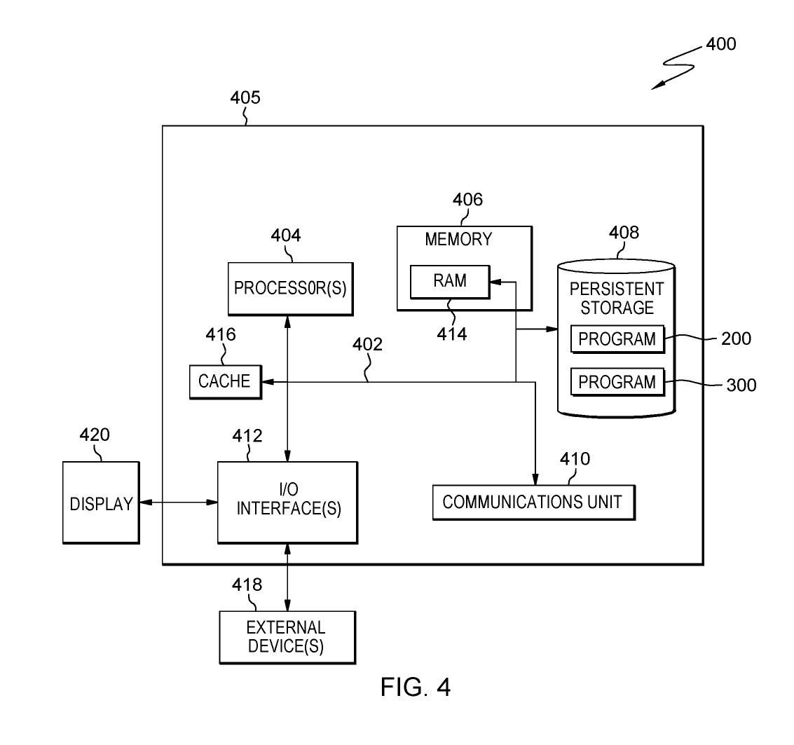

FIG. 4 depicts a block diagram of components of computing system 400, which includes computing device 405. Computing device 405 includes components and functional capability similar to server 110 and smart device 130 (FIG. 1), in accordance with an illustrative embodiment of the present invention. It should be appreciated that FIG. 4 provides only an illustration of one implementation and does not imply any limitations with regard to the environments in which different embodiments may be implemented. Many modifications to the depicted environment may be made.

Computing device 405 includes communications fabric 402, which provides communications between computer processor(s) 404, memory 406, persistent storage 408, communications unit 410, and input/output (I/O) interface(s) 412. Communications fabric 402 can be implemented with any architecture designed for passing data and/or control information between processors (such as microprocessors, communications and network processors, etc.), system memory, peripheral devices, and any other hardware components within a system. For example, communications fabric 402 can be implemented with one or more buses.

Memory 406, cache memory 416, and persistent storage 408 are computer readable storage media. In this embodiment, memory 406 includes random access memory (RAM) 414. In general, memory 406 can include any suitable volatile or non-volatile computer readable storage media.

Device training program 200, and device context program 300 are stored in persistent storage 408 for execution by one or more of the respective computer processors 404 via one or more memories of memory 406. In this embodiment, persistent storage 408 includes a magnetic hard disk drive. Alternatively, or in addition to a magnetic hard disk drive, persistent storage 408 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 408 may also be removable. For example, a removable hard drive may be used for persistent storage 408. Other examples include optical and magnetic disks, thumb drives, and smart cards that are inserted into a drive for transfer onto another computer readable storage medium that is also part of persistent storage 408.

Communications unit 410, in these examples, provides for communications with other data processing systems or devices, including resources of distributed data processing environment 100, and devices of environments connected to network 150. In these examples, communications unit 410 includes one or more network interface cards. Communications unit 410 may provide communications through the use of either or both physical and wireless communications links. Device training program 200, and device context program 300 may be downloaded to persistent storage 408 through communications unit 410.

I/O interface(s) 412 allows for input and output of data with other devices that may be connected to computing system 400. For example, I/O interface 412 may provide a connection to external devices 418 such as a keyboard, keypad, a touch screen, and/or some other suitable input device. External devices 418 can also include portable computer readable storage media such as, for example, thumb drives, portable optical or magnetic disks, and memory cards. Software and data used to practice embodiments of the present invention, e.g., device training program 200, and device context program 300 can be stored on such portable computer readable storage media and can be loaded onto persistent storage 408 via I/O interface(s) 412. I/O interface(s) 412 also connect to a display 420.

Display 420 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method for providing a notification of an unexpected pattern associated with a smart device, the method comprising:
one or more processors detecting information from one or more additional devices within a detectable vicinity of a first smart device;
one or more processors identifying the one or more additional devices by analyzing the information detected from the one or more additional devices;
one or more processors accessing contextual information corresponding to the first smart device;
one or more processors determining expected patterns corresponding to the first smart device, based on compiling combinations of additional devices in the detectable vicinity of the first smart device and the contextual information corresponding to the detectable vicinity of the first smart device, over a predetermined timeframe; and
responsive to determining inconsistency between the expected patterns corresponding to the first smart device over the predetermined timeframe, and the information detected from the one or more additional devices within a current detectable vicinity of the first smart device in combination with current contextual information corresponding to the current detectable vicinity of the first smart device, one or more processors generating a notification indicating an unexpected pattern of the first smart.

2. The method of claim 1, wherein determining expected patterns corresponding to the first smart device, further comprises:
one or more processors identifying known devices in the detectable vicinity of the first smart device and known contextual information corresponding to the detectable vicinity of the first smart device by supervised machine learning.

3. The method of claim 1, wherein the contextual information includes one or a combination selected from a group of: location, date, time, day of the week, and altitude corresponding to the first smart device.

4. The method of claim 3, wherein the contextual information corresponding to the first smart device includes information from scheduling activity functions of the first smart device.

5. The method of claim 1, wherein the unexpected patterns are based on determining devices in the detectable vicinity of the first smart device and the contextual information corresponding to the detectable vicinity of the first smart device indicate the first smart device is lost or stolen.

6. The method of claim 1, wherein the combination of detected devices within the detectable vicinity of the smart device and the contextual information associated with the first smart device defines an environment of the first smart device.

7. The method of claim 1, wherein determining expected patterns corresponding to the first smart device that are based on compiling, over a predetermined timeframe, combinations of detected additional devices in the detectable vicinity of the first smart device, and the contextual information corresponding to the detectable vicinity of the first smart device, includes applying supervised learning techniques to a neural network model.

8. The method of claim 7 wherein the neural network model is based on one or a combination of a multi-layer perceptron (MLP) and a Long/Short Term Memory (LSTM) recurrent neural network model.

9. A computer program product for providing a notification of an unexpected pattern associated with a smart device, the method comprising:
one or more computer readable storage media wherein the computer readable storage medium is not a transitory signal per se, and program instructions stored on the one or more computer readable storage media, the program instructions comprising:
program instructions to detect information from one or more additional devices within a detectable vicinity of a first smart device;
program instructions to identify the one or more additional devices by analyzing the information detected from the one or more additional devices;
program instructions to access contextual information corresponding to the first smart device;
program instructions to determine expected patterns corresponding to the first smart device, based on compiling combinations of additional devices in the detectable vicinity of the first smart device and the contextual information corresponding to the detectable vicinity of the first smart device, over a predetermined timeframe; and
responsive to determining inconsistency between the expected patterns corresponding to the first smart device over the predetermined timeframe, and the information detected from the one or more additional devices within a current detectable vicinity of the first smart device in combination with current contextual information corresponding to the current detectable vicinity of the first smart device, program instructions to generate a notification indicating an unexpected pattern of the first smart.

10. The computer program product of claim 9, wherein the expected patterns of the first smart device, further comprise:
program instructions to identify known devices in the detectable vicinity of the first smart device and known contextual information corresponding to the detectable vicinity of the first smart device by supervised machine learning.

11. The computer program product of claim 9, wherein the contextual information includes one or a combination selected from a group of: location, date, time, day of the week, and altitude corresponding to the first smart device.

12. The computer program product of claim 11, wherein the contextual information corresponding to the first smart device includes information from scheduling activity functions of the first smart device.

13. The computer program product of claim 9, wherein the unexpected patterns are based on program instructions to determine devices in the detectable vicinity of the first smart device and the contextual information corresponding to the detectable vicinity of the first smart device indicate the first smart device is lost or stolen.

14. The computer program product of claim 9, wherein the combination of detected devices within the detectable vicinity of the smart device and the contextual information associated with the first smart device, defines an environment of the first smart device.

15. The computer program product of claim 9, wherein program instructions to determine expected patterns corresponding to the first smart device that are based on compiling, over a predetermined timeframe, combinations of detected additional devices in the detectable vicinity of the first smart device, and the contextual information corresponding to the detectable vicinity of the first smart device, includes applying supervised learning techniques to a neural network model.

16. The computer program product of claim 15, wherein the neural network model is based on one or a combination selected from a group of: a multi-layer perceptron (MLP) and a Long/Short Term Memory (LSTM) recurrent neural network model.

17. A computer system for providing a notification of an unexpected pattern associated with a smart device, the computer system comprising:
one or more computer processors, one or more computer readable storage media, program instructions stored on the computer readable storage media for execution by at least one of the one or more processors, the program instructions comprising:
program instructions to detect information from one or more additional devices within a detectable vicinity of a first smart device;
program instructions to identify the one or more additional devices by analyzing the information detected from the one or more additional devices;
program instructions to access contextual information corresponding to the first smart device;
program instructions to determine expected patterns corresponding to the first smart device, based on compiling combinations of additional devices in the detectable vicinity of the first smart device and the contextual information corresponding to the detectable vicinity of the first smart device, over a predetermined timeframe; and
responsive to determining inconsistency between the expected patterns corresponding to the first smart device over the predetermined timeframe, and the information detected from the one or more additional devices within a current detectable vicinity of the first smart device in combination with current contextual information corresponding to the current detectable vicinity of the first smart device, program instructions to generate a notification indicating an unexpected pattern of the first smart.

18. The computer system of claim 17, wherein the contextual information includes one or a combination selected from a group of: location, date, time, day of the week, and altitude corresponding to the first smart device, and wherein the contextual information corresponding to the first smart device includes information from scheduling activity functions of the first smart device, and wherein the unexpected patterns are based on program instructions to determine devices in the detectable vicinity of the first smart device and the contextual information corresponding to the detectable vicinity of the first smart device indicate the first smart device is lost or stolen.

19. The computer system of claim 17, wherein program instructions to determine expected patterns corresponding to the first smart device that are based on compiling over a predetermined timeframe, combinations of detected additional devices in the detectable vicinity of the first smart device, and the contextual information corresponding to the detectable vicinity of the first smart device, include applying supervised learning techniques to a neural network model.

20. The computer system of claim 17, wherein the neural network model is based on one or a combination selected from a group of: a multi-layer perceptron (MLP) and a Long/Short Term Memory (LSTM) recurrent neural network model.
